(19) United States
(12) Patent Application Publication
(10) Pub. No.: US 2009/0147825 A1
(43) Pub. Date: Jun. 11, 2009

(54) ELECTRONIC THERMOMETER SENSOR TIP

(75) Inventors: Roch Chian HO, Houston, TX (US); Chiu Chung TAI, Houston, TX (US)

Correspondence Address: CONLEY ROSE, P.C.;David A. Rose, P. O. BOX 3267, HOUSTON, TX, 77253-3267, US

(73) Assignee: AMPEROR, INC., Houston, TX (US)

(21) Appl. No.: 12/188,799

(22) Filed: Aug. 8, 2008

(30) Foreign Application Priority Data
Dec. 7, 2007 (CN) 200720194456.1

(51) Int. Cl. G01K 7/22

(52) U.S. Cl. 374/185; 374/E07.028

(57) ABSTRACT

A sensor tip for use in an electronic thermometer is disclosed herein. An electronic thermometer includes a metal cap having a cavity and a temperature transducer. The temperature transducer is affixed within the cavity by solder. Wires connecting the temperature transducer to a circuit of the electronic thermometer form a spiral around the interior of the cap such that the wires make contact with the cap at a plurality of points.

### CROSS-REFERENCE TO RELATED APPLICATIONS

This application claims benefit of Patent Application No. 200720194456.1, filed Dec. 7, 2007 in the People's Republic of China, and entitled “Sensor Tip Design Used in Electronic Body and Ear Thermometer” hereby incorporated herein by reference.

### STATEMENT REGARDING FEDERALLY SPONSORED RESEARCH OR DEVELOPMENT

Not applicable.

### BACKGROUND

1. Field of the Invention

This patent application describes a sensor tip used for an electronic thermometer configured to measure body temperature.

2. Background of the Invention

Various existing sensor tips used for electronic thermometers are comprised of a metal cap, a sensor (e.g., a thermistor), and foamed plastic. In constructing the tip, thermal conductive compound is applied to the sensor. Foamed plastic is used to press the sensor into a cavity of the metal cap. Thermal conductive compound covers the sensor and contacts the inner surface of the cavity of the metal cap. The thermal conductive compound thus provides thermal conductivity from the cap to the sensor.

The amount of thermal conductive compound applied can be very difficult to control. Excess thermal conductive compound can reduce thermal conductivity efficiency and increase the sensing time of the electronic thermometer. Moreover, the foamed plastic can be severely deformed resulting in variation of the sensor location, which in turn can cause a slow response time and unstable readings. The foamed plastic is also considered an environmentally hazardous material and is unacceptable in many countries.

### SUMMARY

A variety of novel embodiments of electronic thermometers are herein disclosed. The disclosed embodiments provide improved thermometer response time and reading reliability by more accurately positioning the temperature sensor/transducer within the sensor tip. Moreover, embodiments have no need for foamed plastic material, and thus comply with various environmental protection requirements.

In accordance with at least some embodiments, an electronic thermometer comprises a metal cap and a temperature transducer. The metal cap further comprises a cavity. The temperature transducer is affixed within the cavity of the cap by solder.

In some embodiments, an electronic thermometer comprises a metal cap and a first wire disposed within the cap. The first wire connects a temperature transducer to a circuit of the electronic thermometer. The first wire forms a coiling spiral against the inner surface of the cap.

In yet other embodiments, an electronic thermometer comprises a temperature transducer, a metal cap, and means for metallically bonding the temperature transducer to the metal cap.

### Notation and Nomenclature

Certain terms are used throughout the following description and claims to refer to particular system components. As one skilled in the art will appreciate, companies may refer to a component by different names. This document does not intend to distinguish between components that differ in name but not function. In the following discussion and in the claims, the terms “including” and “comprising” and “e.g.” are used in an open-ended fashion, and thus should be interpreted to mean “including, but not limited to . . . ”. The term “couple” or “couples” is intended to mean either an indirect or direct connection. Thus, if a first component couples to a second component, that connection may be through a direct connection, or through an indirect connection via other components and connections.

### BRIEF DESCRIPTION OF THE DRAWING

For a detailed description of the exemplary embodiments of the invention, reference will now be made to the accompanying drawings in which:

FIG. 1 shows a sensor tip of an electronic thermometer in accordance with various embodiments.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

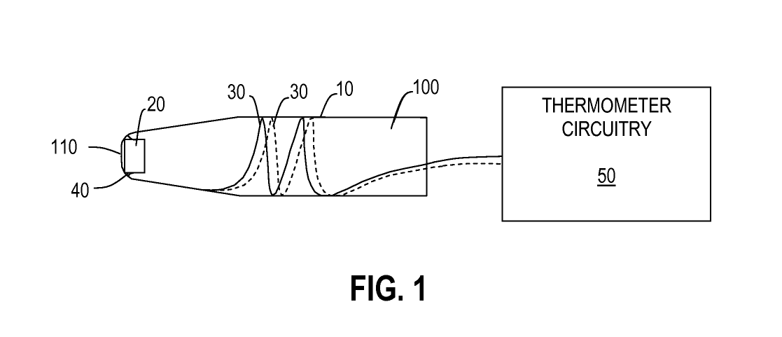

FIG. 1 shows a sensor tip of an electronic thermometer in accordance with various embodiments. The exemplary sensor tip includes a metal cap 10, a temperature sensor or temperature transducer 20, and two sensor wires 30. A variety of temperature transducers may serve as the sensor 20 including, for example, a thermistor. The sensor 20 includes two electrical contacts. Each of the two sensor wires 30 are soldered onto one of the two electrical contacts of the sensor 20. The metal cap 10 is of such length and diameter to be suitable for use in an electronic thermometer. In one embodiment, for example, the metal cap 10 has a length of approximately 12.06 millimeters (“mm”), an outer diameter of approximately 4.29 mm and an inner diameter of approximately 3.99 mm. Those skilled in the art will understand that a wide variety of cap 10 dimensions may be suitable, and accordingly embodiments of the present disclosure are not restricted to any particular size of metal cap 10.

The metal cap 10 includes a cavity 100, i.e., the cap 10 is hollow. The sensor 20 and the sensor wires 30 are disposed within the cavity 100. The sensor 20 is fixed to the front inner surface of the cavity 100 of the metal cap 10 by solder 40. As explained supra, in some embodiments sensor 20 is a thermistor. More specifically, some embodiments may employ a SEMITEC® 503ET-3H160-20070 thermistor. However, embodiments of the present disclosure are not limited to any particular thermistor, or any particular temperature transducer technology. In some embodiments, the surface of the sensor 20 attached to the metal cap 10 by solder 40 comprises an electrical contact of the sensor 20. Accordingly, soldering an electrical contact of the sensor 20 to the metal cap 10 results in a wire 30 connected to that contact also being soldered to the metal cap 10.

Embodiments of the present disclosure, thus advantageously include a solder joint 40 that causes the sensor 20 to form an intimate connection with the tip 110 of the metal cap 10 providing improved thermal conductivity between the caplo and the sensor 20. Sensor tip embodiments, relying on thermally conductive compounds or adhesives to transfer heat from the metal cap 10 to the sensor 20, fail to provide such direct contact between the cap 10 and the sensor 20. Additionally, thermally conductive compounds or adhesives may degrade over time resulting in increased sensor 20 response times over the life of the thermometer. Moreover, by soldering the sensor 20 to the metal cap 10, embodiments of the present disclosure advantageously avoid the use of foamed plastic, and the attendant environmental issues, provide more accurate sensor 20 positioning, and more consistent measurements.

The solder joint 40 between the sensor 20 and the metal cap 10 may be formed by a variety of soldering methods known to those skilled in the art. For example, solder paste of appropriate composition may be deposited at the tip 110 of the metal cap 10. The sensor 20 and attached connection wires 30 may be positioned in the tip 100 of the metal cap 10. Appropriate heat may then be applied to reflow the solder and form the solder joint 40 between the metal cap 10 and the sensor 20. Those skilled in the art will recognize that a variety of soldering methods and solder compositions may be employed to form the solder joint 40 between the metal cap 10 and the sensor 20, and that embodiments of the present disclosure are not limited to any particular solder composition or soldering method.

The two sensor wires 30 connect the sensor 20 to the circuitry 50 of the electronic thermometer, thus providing signals representative of the temperature of the metal cap 10 to the circuitry 50. Thermometer circuitry 50 includes various components, for example, an analog-to-digital converter, microcontroller, display controller, etc., that convert the temperature transducer 20 output signals into a human useable temperature value. The two wires 30 are spiraled inside the cavity 100 of the metal cap 10. In some embodiments, the two wires 30 form a twisted pair. The two sensor wires 30 are shaped into a spiral form inside the cavity 100, and make numerous contacts with the inner surface of the cavity 100. The numerous contacts between the sensor wires 30 and the metal cap 10 help to equalize the sensor wires 30 temperature to the metal cap 10 temperature. Thus, embodiments of the present disclosure increase the accuracy and speed of the electronic thermometer by conducting heat directly from the metal cap 10 to the sensor wires 30. The spiral shape of the two sensor wires 30 can also serve as a strain relief to prevent breakage of the connections between sensor wires 30 and sensor 20 electrical contacts. In some embodiments, each wire 30 is 36 AWG copper with high thermal polyurethane, tinnable polyester-imide, or thermal tinnable polyester-imide enamel insulation, however, embodiments of the present disclosure not limited to a particular wire size, composition, or insulation type.

Some embodiments may employ patterns of wires 30 other than the spiral to create numerous contacts between the wires 30 and the metal cap 10. The present disclosure encompasses all embodiments that equalize the temperature of the wires 30 to the temperature of the metal cap 10 by providing numerous contact points between the wires 10 and the metal cap 10.

A cambered (arc) surface is formed on the outer surface of the tip 110 of the metal cap 10. Embodiments thus provide a more comfortable interaction between the metal cap 10 and the human body during temperature measurement.

While illustrative embodiments of this invention have been shown and described, modifications thereof can be made by one skilled in the art without departing from the spirit or teaching of this invention. The embodiments described herein are illustrative and are not limiting. Many variations and modifications of the methods and apparatus are possible and are within the scope of the invention. Accordingly, the scope of protection is not limited to the embodiments described herein, but is only limited by the claims which follow, the scope of which shall include all equivalents of the subject matter of the claims.

What is claimed is:

1. An electronic thermometer, comprising:
a metal cap having a cavity at the end thereof; and a temperature transducer, the temperature transducer being affixed within the cavity of the cap by solder.

2. The electronic thermometer of claim 1, further comprising a wire pair, each wire of the pair connected to an electrical contact of the transducer, wherein the wire pair makes contact with the cap at a plurality of points.

3. The electronic thermometer of claim 2, wherein the wire pair forms a spiral around the interior of the cap.

4. The electronic thermometer of claim 1, wherein one electrical contact of the transducer is soldered to the cap.

5. The electronic thermometer of claim 1, wherein the temperature transducer is affixed with the cavity at the tip of the cap.

6. The electronic thermometer of claim 1, wherein the tip of the cap is convex.

7. An electronic thermometer, comprising:
a metal cap;
a first wire disposed within the cap, connecting a temperature transducer to a circuit of the electronic thermometer;
wherein the first wire contacts a plurality of points on the inner surface of the cap.

8. The electronic thermometer of claim 7, wherein the first wire forms a spiral against the inner surface of the cap.

9. The electronic thermometer of claim 7, further comprising a second wire twisted with the first wire to form a twisted pair, and wherein the twisted pair forms a spiral against the inner surface of the cap.

10. The electronic thermometer of claim 7, wherein the temperature transducer is attached to the inner surface of the cap by solder.

11. The electronic thermometer of claim 7, wherein the temperature transducer comprises a plurality of electrical contacts, and an electrical contact of the transducer is attached to the inner surface of the cap by solder.

12. The electronic thermometer of claim 1, wherein the transducer is attached to the tip of the cap by solder.

13. The electronic thermometer of claim 1, wherein the first wire is attached to the cap by solder.

14. The electronic thermometer of claim 1, wherein the temperature transducer comprises a thermistor.

15. An electronic thermometer, comprising:
a temperature transducer;
a metal cap; and
means for metallically bonding the temperature transducer to the metal cap.

16. The electronic thermometer of claim 15, further comprising:
a first wire that couples the temperature transducer to a circuit of the electronic thermometer; and
means for directly transferring heat from the cap to the first wire.

17. The electronic thermometer of claim 16, wherein the first wire is connected to a first electrical contact of the temperature transducer and the first wire is metallically bonded to the inner surface of the cap.

18. The electronic thermometer of claim 16, further comprising:
a second wire connected to a second electrical contact of the temperature transducer, the second wire coupling the temperature transducer to a circuit of the electronic thermometer; and
means for directly transferring heat from the cap to the second wire.

19. The electronic thermometer of claim 15, wherein a first electrical contact of the temperature transducer is metallically bonded to the cap.

20. The electronic thermometer of claim 15, wherein the temperature transducer is metallically bonded to the tip of the cap.
